(19) United States
(12) Patent Application Publication
(10) Pub. No.: US 2017/0007074 A1
(43) Pub. Date: Jan. 12, 2017

(54) Single Use Insulated Expandable Food Delivery Bag

(71) Applicant: Giuseppe DiFiore, Schnecksville, PA (US)

(72) Inventor: Giuseppe DiFiore, Schnecksville, PA (US)

(21) Appl. No.: 14/794,996

(22) Filed: Jul. 9, 2015

(51) Int. Cl. A47J 41/00; B65D 33/24; B65D 33/01

(52) U.S. Cl. CPC A47J 41/0066; A47J 41/0072; B65D 33/01; B65D 33/24

(57) ABSTRACT

A flexible, expandable, insulated food delivery bag system for maintaining heated foodstuffs at temperature having plural arrays of openings for permitting heated moist air to escape from the interior of the bag system to prevent the contained foodstuffs from becoming soggy. The bag system closure is effected by adhesion of paired hook and loop strips located on the elongated closure flap and on the bag exterior or an adhesive strip located on the closure flap and overlaid onto the exterior of the bag system with a tear strip located in the flap for reopening the bag upon delivery.

### BACKGROUND OF THE INVENTION

The present invention relates to a single use insulated expandable food delivery bag commonly utilized for delivering food products such as hot pizza within a paperboard box. Multiple use flexible delivery containers or bags have been used for some time, but have the known deficiency of becoming contaminated with food spills and particles which are difficult to remove and clean such that food cleanliness can be maintained and preserved for the multi-use container system. Thus, the life time for use of the multi-use container system is dependent solely on maintaining the interior of the bag to a high standard of food cleanliness which is difficult due to the narrowness of the opening giving rise to an inability to properly be able to scrub clean the interior surfaces to remove food spills and particles. Further, these multi-use bags also retain smells within the bag lining materials that are impregnated when the hot foodstuffs are placed in the bag and which are enhanced when other hot foodstuffs are later placed in the same bag. All of this creates a potential unsanitary environment for newly cooked foodstuffs that are being delivered in a heated state.

It is, therefore, an object of the present invention to maintain a high level of food cleanliness by utilizing the flexible insulated bag system only once thereby eliminating any requirement to clean away food spills or particles that remain after delivery. It is also an object of the present invention to provide a flexible insulated bag system that can accommodate more than one size rigid delivery container within and to accommodate at least two such rigid containers while maintaining a warmed atmosphere within the bag system. It is a still further object of the present invention to allow for any collected steam or hot humid air to exit the bag system through a series of apertures arrayed along the periphery of the bag system while maintaining an elevated temperature within the bag system to retain a non-soggy foodstuff within the rigid container housed within the bag system.

Other objects will appear hereinafter.

### SUMMARY OF THE INVENTION

A single use flexible, expandable food delivery bag is described comprising a pair of sidewalls, a rear wall, and a top and a bottom with a flap extending outward from the top and downward over the front opening to effect closure of the opening. Each of the sidewalls, the rear wall, the top and bottom, and the flap all contain a layer of insulating material between their outward facing surfaces to preserve the temperature of the environment within the food delivery bag. Each of the sidewalls and the rear wall have a gusset for expansion of the food delivery bag from a collapsed state to a partially expanded state and to a fully expanded state. A series of apertures are arrayed around the food delivery bag to permit the escape of heated moist air accumulating within the food delivery bag from heated foodstuffs placed within the food delivery bag. The flap has a sufficient length to overlie the bottom of the food delivery bag for a distance proportionate to the state of expansion of the food delivery bag. The flap is secured in position to close off the interior of the food delivery bag thereby maintaining the contained foodstuffs at a heated temperature until delivery.

The gussets in each of the sidewalls and rear wall of the food delivery bag are expandable to accommodate one or more rigid food containers within the food delivery bag. The series of apertures in the food delivery bag, for permitting the escape of heated moist air from within the food delivery bag, are arrayed around the periphery of the top of the food delivery bag and along the sidewalls and rear wall in sufficient number to permit the heated moist air to escape from the food delivery bag to prevent the foodstuffs from absorbing the moisture and becoming soggy while maintaining the foodstuffs in a heated condition for an extended period of time.

The elongated flap of the food delivery bag is held in its closed position by a paired set of Velcro® strips located on the flap and on the bottom of the food delivery bag in a partially expanded position and a fully expanded position to close off the front opening. Alternatively, the flap of food delivery bag is held in its closed position by an adhesive strip that is adhered directly to the bottom of the food delivery bag to close off the front opening. The food delivery bag further includes a tear strip located in the elongated flap for reopening the food delivery bag upon delivery when the adhesive strip is used for closing the front opening of the food delivery bag.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a perspective view of the flexible insulated bag system of the present invention.

FIG. 2 is a rear view of the flexible insulated bag system of the present invention showing a single rigid container housed therein.

FIG. 3 is a cross-sectional view of the flexible insulated bag system of the present invention showing plural rigid containers housed therein.

FIG. 4 is a cross-sectional view of the flexible insulated bag system of the present invention showing a single rigid container housed therein.

FIG. 5 is a side view of the flexible insulated bag system of the present invention showing plural rigid containers housed therein.

FIG. 6 is a partially cut-away front view of the flexible insulated bag system of the present invention showing plural rigid containers housed therein.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

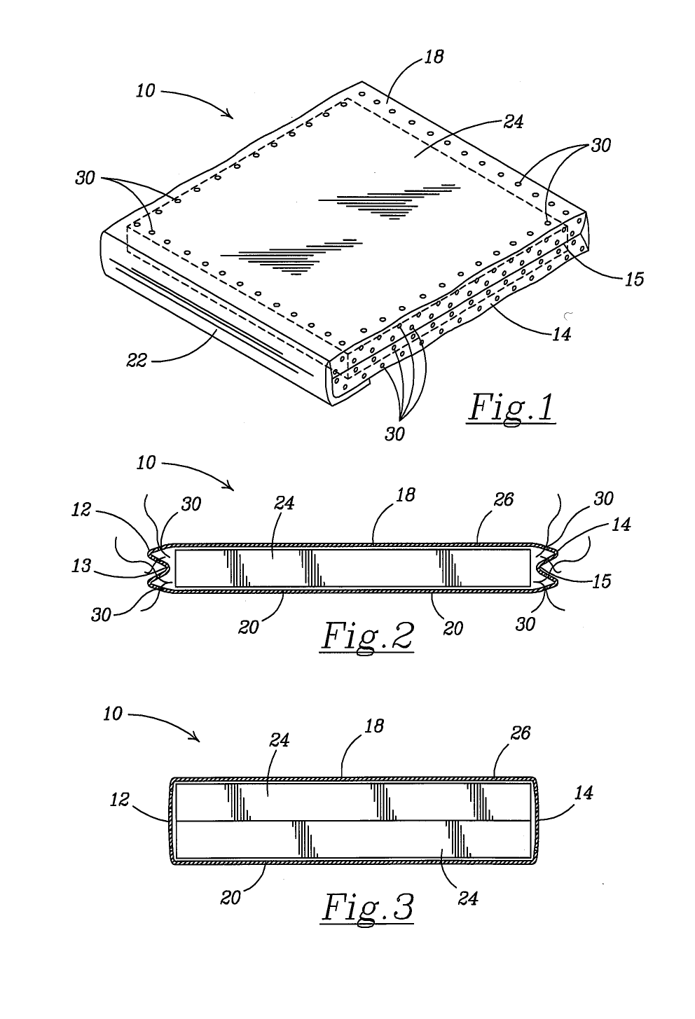

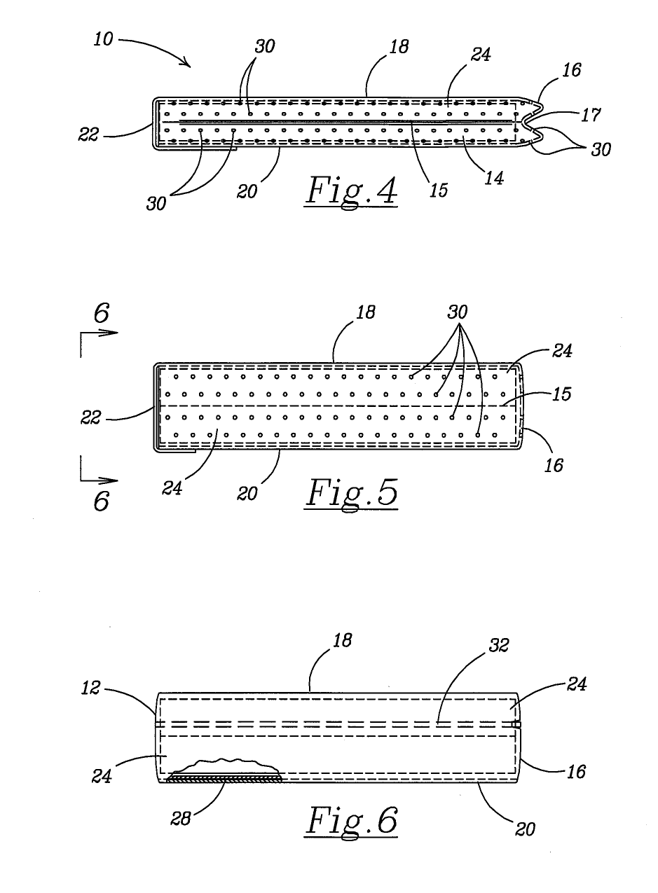

Referring now to the drawings in detail, where like numerals refer to like parts or elements, there is shown in FIG. 1 the flexible insulated expandable bag system 10 of the present invention. The bag system 10 has gussets 13, 15 on each of its two sidewalls 12, 14 which are best seen in FIG. 2. An additional gusset 17 exists in rear wall 16 of the bag system 10 as best shown in FIG. 4. The top 18 and bottom 20, as well as the sidewalls 12, 14 and rear wall 16 of the bag system 10 all house within the outer layers insulating foam 26 that allows limited flexibility for the bag system peripheral members while providing relative temperature constancy within the bag system 10. The front flap 22 closes off the large opening in the bag system 10 used for inserting rigid containers holding foodstuffs, such as the pizza box 24 shown in phantom lines in FIG. 1. The closure flap 22 can be held in position across the front edge portion of the bottom 20 of the bag system 10 by any number of attachment devices. These can be paired Velcro® closure strips 28, or a single use adhesive strip, applied to both the flap 22 and the bottom 20.

The bag system 10 can accommodate more than just a single rigid container. Referring to FIGS. 2 and 3, with a single container 24 housed within the bag system 10 the gussets 13, 15 in the sidewalls 12, 14 are not fully expanded. When two rigid containers 24 are inserted into the bag system 10, the gussets 13, 15 in the sidewalls 12, 14 are fully expanded to accommodate the plurality of containers as shown in FIG. 3. The flap 22 is of sufficient length to accommodate either the single or plural containers 24 within the bag system 10 without compromising the temperature insulative property of the bag system in effective closure of the large opening in the front of the bag system 10.

In order to overcome the problem of accumulating hot moisture within the bag system 10 from the heated foodstuffs contained therein, a series of heated moisture escape apertures or openings 30 are situated around the bag system to permit the escape of the heated moist air that if remained contained within the bag system 10 would likely render the foodstuffs soggy. The openings 30 are arrayed around the periphery of the top 18, along the entire length of sidewalls 12, 14, and along the back wall 16 of the bag system 10. The openings 30 located on the top 18 of the bag system 10 are approximately equi-distant from each other along the periphery in order to permit the heated moist air to escape from the rigid container(s) 24 and from the bag system 10 while retaining the foodstuffs at an elevated heated temperature. Also, the openings 30 in the sidewalls 12, 14 and the back wall 16 are arrayed in parallel in one or more lines of equi-distant openings 30 both above and below the gussets 13, 15 and 17. As shown, there are two lines of openings 30 that are arrayed above and below the gussets 13, 15 and 17, but one or more lines of openings 30 will suffice with the number of lines being dependent upon the size of the openings 30 to permit greater or lesser amounts of heated moist air to escape through any given opening 30. Reference can be made to FIG. 2 to show the escape of the heated moist air (shown in solid lines) from the openings 30 in the sidewalls 12, 14. The openings are positioned in the sidewalls 12, 14 and the back wall 16, as well as along the outer periphery of the top 20 to accommodate the least distance possible for the heated moist air to travel within the bag system 10 when released from the unsecured openings of the rigid container(s) 24 housed within the bag system 10. In this way the heated moist air is resident within the bag system 10 for only a minimal amount of time.

Referring to FIG. 6, the closure system 28 for the bag system is shown along the bottom 20 of the bag system 10. As described above, the closure system 28 can be a set of paired Velcro® strips arrayed across the bottom 20 and the closure flap 22 that will secure the flap 22 to the bottom 20 until delivery is completed. Alternatively, a single use adhesive strip can be used to secure the flap 22 to the bottom 20. Depending upon the use of the bag system to contain one or plural rigid containers 24, the Velcro® strip along the bottom 20 needs to be positioned in a close or a distant position to accommodate the edge of the flap 22 for the size of the contents, a longer distance is required for a single container 24 housed within the bag system 10. Alternatively, only one adhesive strip 28 is required to be placed at the edge of the flap 22 with the bag system 10 being utilized as the contact point (or line) for adhering to the adhesive strip 28. Further, if an adhesive strip is used as the closure 28 for the bag system 10, an additional tear strip 32, located partway along the length of the flap 22, can be utilized to open the bag system once sealed with the foodstuff container(s) 24 inside.

As described, the bag system 10 is used to house one or more rigid containers 24 containing heated foodstuffs. The expandable gussets 13, 15 and 17, located on the sides and rear of the bag system 12, 14 and 16, are designed to accommodate one or more rigid containers 24, in the cases shown pizza boxes. However, the bag system 10 could be dimensioned to accommodate greater number of containers. When closed using either of the described closure systems 28, the flap 22 closes off the large opening in the front of the bag system and is secured to the bottom 20. The openings 30 permit heated moist air that accumulates within the bag system 10, as given off by the heated foodstuffs within the containers 24, to escape from the bag system 10 preventing the foodstuffs from absorbing the moisture and becoming soggy. Upon delivery, the bag system 10 can be opened by peeling off one side of the Velcro® strips 28 from the other, by peeling away the adhesive strip 28 from the bag system 10, or by utilizing an additional tear strip 32 located in the flap 22 to open the bag system for access to the heated foodstuffs kept at an elevated heated temperature by the insulative properties of the bag system 10.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A single use flexible, expandable food delivery bag comprising:
a pair of sidewalls, a rear wall, and a top and a bottom with an elongated flap extending outward from the top and downward over the front opening to effect closure of the opening, said sidewalls, rear wall, top and bottom and flap all containing a layer of insulating material between their outward facing surfaces;
said sidewalls and said rear wall each having a gusset for expansion from a collapsed state to a partially expanded state and to a fully expanded state;
a series of apertures arrayed around said food delivery bag to permit the escape of heated moist air accumulating within the food delivery bag from heated foodstuffs placed within the food delivery bag; and,
said elongated flap being capable of overlying the bottom for a distance proportionate to the state of expansion of the food delivery bag and being secured in position to close off the interior of the food delivery bag for maintaining the contained foodstuffs at a heated temperature until delivery.

2. The food delivery bag of claim 1, wherein the gussets in each of the sidewalls and rear wall are capable of expansion to accommodate one or more rigid food containers within the food delivery bag.

3. The food delivery bag of claim 1, wherein the series of apertures for permitting the escape of heated moist air from within the food delivery bag are arrayed around the periphery of the top of the food delivery bag and along the sidewalls and rear wall in sufficient number to permit the heated moist air to escape from the food delivery bag to prevent the foodstuffs from absorbing the moisture and becoming soggy while maintaining the foodstuffs in a heated condition for an extended period of time.

4. The food delivery bag of claim 1, wherein the elongated flap is held in its closed position by a paired set of hook and loop strips located on the elongated flap and on the bottom of the food delivery bag in a partially expanded position and a fully expanded position to close off the front opening.

5. The food delivery bag of claim 1, wherein the elongated flap is held in its closed position by an adhesive strip that is adhered to the bottom of the food delivery bag to close off the front opening.

6. The food delivery bag of claim 1, further comprising a tear strip located in the elongated flap for reopening the food delivery bag upon delivery when the adhesive strip is used for closing the front opening in the food delivery bag.
